(19) United States
(12) Patent Application Publication
(10) Pub. No.: US 2010/0073716 A1
(43) Pub. Date: Mar. 25, 2010

(54) Method and Apparatus for Forming a Document Set

(75) Inventor: Tamas Hume, Fitzroy (AU)

Correspondence Address: THE WEBB LAW FIRM, P.C., 700 KOPPERS BUILDING, 436 SEVENTH AVENUE, PITTSBURGH, PA, 15219, US

(73) Assignee: ENVELOPMENTS PTY LTD., Fitzroy (AU)

(21) Appl. No.: 12/517,282

(22) PCT Filed: Dec. 5, 2007
(86) PCT No.: PCT/AU07/01877

§ 371 Date: Jun. 2, 2009

(30) Foreign Application Priority Data
Dec. 5, 2006 (AU) 2006906796

(51) Int. Cl. G06F 15/00

(52) U.S. Cl. 358/1.15

(57) ABSTRACT

A method for forming a document set is described. The document set is formed from rectangular sheets and includes an envelope sheet and at least one insert sheet where the at least one insert sheet and the envelope sheet are selected from a range of industry standard rectangular sizes. The method further includes the steps of printing the envelope sheet with envelope information, the envelope information including a unique code identifier and also printing each of the at least one insert sheets with insert information, the insert information including a unique code identifier and then collating the envelope sheet and the at least one insert sheet to form the document set.

### PRIORITY

The present application for patent claims priority from Australian Provisional Patent Application No. 2006906796 entitled “METHOD AND APPARATUS FOR FORMING A DOCUMENT SET” filed 5 Dec. 2006, which is hereby incorporated by reference herein in its entirety.

### FIELD OF THE INVENTION

The present invention relates to processes for generating bulk mail out items. In a particular form, the present invention relates to forming a document set for further processing into a mail out item.

### BACKGROUND OF THE INVENTION

In the earlier filed PCT Application No PCT/AU2004/000446 entitled “Method and Apparatus for Forming a Document Set” whose disclosure is herein incorporated in its entirety by reference, the present applicant discloses a method and apparatus for forming a document set that is formed from rectangular sheets of the same size and that includes an envelope sheet and at least one insert sheet. The method further includes the steps of printing the envelope sheet with envelope information where the envelope information includes a unique code identifier, printing each of the at least one insert sheets with insert information where the insert information includes a unique code identifier and then collating the envelope sheet and at least one insert sheet to form the document set.

Although this arrangement is still considered quite satisfactory for most applications, there are those instances where there may be specialised requirements for the size and/or configuration of the envelope with respect to the insert sheets. These situations may include where a different shaped envelope is required for marketing purposes or where a more secure envelope is needed. Other circumstances include where it is necessary to print the full extent of a standard size page i.e. a bleed to the edge of the paper.

### SUMMARY OF THE INVENTION

In a first aspect the present invention accordingly provides a method for forming a document set, the document set formed from rectangular sheets and including an envelope sheet and at least one insert sheet, the at least one insert sheet and the envelope sheet selected from a range of industry standard rectangular sizes, the method including the steps of:
printing the envelope sheet with envelope information, the envelope information including a unique code identifier;
printing each of the at least one insert sheets with insert information, the insert information including a unique code identifier; and
collating the envelope sheet and the at least one insert sheet to form the document set.

Preferably, there are a plurality of insert sheets and the plurality of insert sheets are of the same industry standard rectangular size.

Preferably, the method further includes the step of forming the envelope sheet into an envelope and wherein the step of collating includes collating the envelope and the at least one insert sheet to form the document set.

Preferably, the step of forming the envelope sheet into an envelope includes die cutting the envelope sheet.

Alternatively, the method further includes the step of forming the envelope into an envelope by folding or wrapping the envelope sheet about the at least one insert sheet.

Preferably, the method further includes the step of verifying the document set by reading each of the unique code identifiers and performing a self-referencing integrity check.

Preferably, the unique code identifier identifies whether a printed sheet is an envelope sheet.

In a second aspect the present invention accordingly provides a method for forming a document set, the document set formed from a rectangular sheet of an industry standard rectangular size, the document set including an envelope sheet and at least one insert sheet, the method including the steps of:
printing an envelope sheet portion of the rectangular sheet with envelope information, the envelope information including a unique code identifier and the envelope sheet portion corresponding to the envelope sheet;
printing an at least one insert sheet portion of the rectangular sheet with insert information, the insert information including a unique code identifier, the at least one insert sheet portion corresponding to the at least one insert sheet;
cutting the rectangular sheet to form the envelope sheet and the at least one insert sheet; and
collating the envelope sheet and the at least one insert sheet to form the document set.

Preferably, the envelope sheet portion is of an industry standard rectangular size.

Preferably, the at least one insert sheet portion is of an industry standard rectangular size.

Preferably, the method further includes the step of verifying the document set by reading each of the unique code identifiers and performing a self-referencing integrity check.

Preferably, the unique code identifier identifies whether a printed sheet portion is an envelope sheet portion.

In a third aspect the present invention accordingly provides a bulk mail out item formed from the document set in accordance with the first and second aspect of the present invention.

In a fourth aspect the present invention accordingly provides an apparatus for forming a document set, the document set formed from rectangular sheets and including an envelope sheet and at least one insert sheet, the at least one insert sheet and the envelope sheet selected from a range of industry standard rectangular sizes, the apparatus including:
printing means for printing the envelope sheet with envelope information, the envelope information-including a unique code identifier and to print each of the at least one insert sheets with insert information, the insert information including a unique code identifier; and
collating means for collating the envelope sheet and the at least one insert sheet to form the document set.

Preferably, there are a plurality of insert sheets and the plurality of insert sheets are of the same industry standard rectangular size.

Preferably, the apparatus includes envelope forming means for forming an envelope prior to collation.

Preferably, the envelope forming means is a die cutter.

In a fifth aspect the present invention accordingly provides an apparatus for forming a document set, the document set formed from a rectangular sheet of an industry standard rectangular size, the document set including an envelope sheet and at least one insert sheet, the apparatus including:
printing means for printing an envelope sheet portion of the rectangular sheet with envelope information, the envelope information including a unique code identifier and the envelope sheet portion corresponding to the envelope sheet, and to print at least one insert sheet portion of the rectangular sheet with insert information, the insert information including a unique code identifier, the at least one insert sheet portion corresponding to the at least one insert sheet;
cutting means for cutting the rectangular sheet to form the envelope sheet and the at least one insert sheet; and
collating means for collating the envelope sheet and the at least one insert sheet to form the document set.

Preferably, the envelope sheet portion is of an industry standard rectangular size.

Preferably, the at least one insert-sheet portion is of an industry standard rectangular size.

### BRIEF DESCRIPTION OF THE DRAWINGS

A preferred embodiment of the present invention will be discussed with reference to the accompanying drawing wherein:

FIG. 1 is a system flowchart illustrating a method for forming a document set according to a preferred embodiment of the present invention.

### DESCRIPTION OF PREFERRED EMBODIMENT

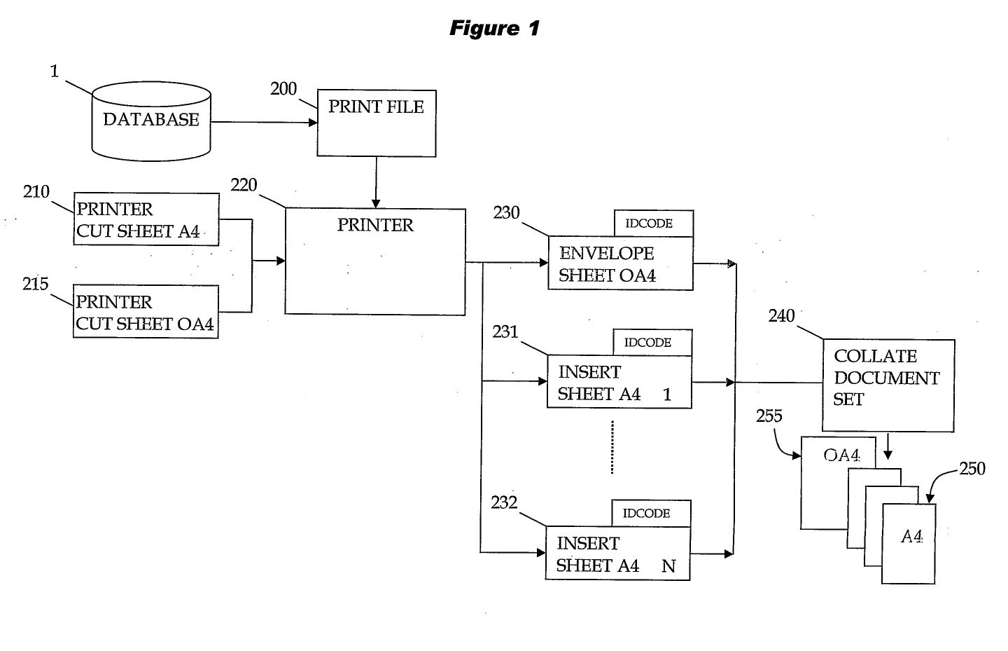

Referring now to FIG. 1, there is shown a system flowchart illustrating a method of forming a document set according to a preferred embodiment of the present invention. Print file 200 is generated from database 1 and contains all information which is printed on each envelope sheet 230 and associated insert sheets 231, 232. This information will include personalised information relevant to each mail item that is to be formed from each document set 250 such as names, addresses, title to be used etc. As would be appreciated by those skilled in the art, this information will generally be customised according to the requirement of the mail out item which will be formed from the document set 250.

In addition to personalised information such as outlined above, print file 200 will include information which will be used to generate a unique code identifier (generally referred to as IDCODE within the description) which will be printed on each of the sheets 230, 231, 232 which form part of document set 250.

Cut sheet 210 in the form of single A4 sheets are fed to printer 220 which prints each individual sheet with insert sheet information as required and a unique IDCODE for each sheet thereby forming at least one uniquely identified insert sheet 231, 232.

Furthermore cut sheet 215 in the form of oversize A4 is fed to printer 220 (as generally indicated by OA4) which prints the envelope sheet 230 with envelope sheet information and a unique IDCODE thereby forming a uniquely identified envelope sheet 230.

Whilst the unique IDCODE may comprise a barcode or other similar machine readable mark, equally the unique IDCODE may comprise a combination of unique printed material that appears on each of the sheets forming the document set. As a non-limiting example, a document set may include an envelope bearing the addressee's name and address:
To: [FIRST_NAME] [LAST_NAME]
   [ADDRESS]
      and a single insert sheet comprising a letter starting with the text:
Dear [FIRST_NAME] [LAST_NAME]

Through the use of image processing and optical character recognition (OCR) techniques, the combination of the word “To” and the addressee's name may be identified and recognised separately from the combination of the word “Dear” and the addressee's name. Accordingly, these text combinations will function to uniquely identify the envelope sheet and the insert sheet, thereby functioning as a unique code identifier.

As would be appreciated by those skilled in the art, these image processing techniques may be extended to analysing and determining any feature of an individual sheet that forms part of a document set which functions to uniquely identify that sheet.

Although, in this embodiment oversize A4 sheet is employed for the envelope sheet, equally the use of any other industry standard size cut sheet that is of a different size to the cut sheet used for the insert sheets is contemplated to be within the scope of the invention. In a further illustrative embodiment, one or more of the insert sheets may also be selected from an industry standard size cut sheet that differs in size from the remaining insert sheets as desired.

As a non-limiting example of industry standard sizes, the following table shows the width and height of all International Organization for Standardization (ISO) A and B paper formats, as well as the ISO C envelope formats (all dimensions in millimeters).

| A Series Formats | | B Series Formats | | C Series Formats | |
|---|---|---|---|---|---|
| 4A0 | 1682 × 2378 | — | — | — | — |
| 2A0 | 1189 × 1682 | — | — | — | — |
| A0 | 841 × 1189 | B0 | 1000 × 1414 | C0 | 917 × 1297 |
| A1 | 594 × 841 | B1 | 707 × 1000 | C1 | 648 × 917 |
| A2 | 420 × 594 | B2 | 500 × 707 | C2 | 458 × 648 |
| A3 | 297 × 420 | B3 | 353 × 500 | C3 | 324 × 458 |
| A4 | 210 × 297 | B4 | 250 × 353 | C4 | 229 × 324 |
| A5 | 148 × 210 | B5 | 176 × 250 | C5 | 162 × 229 |
| A6 | 105 × 148 | B6 | 125 × 176 | C6 | 114 × 162 |
| A7 | 74 × 105 | B7 | 88 × 125 | C7 | 81 × 114 |
| A8 | 52 × 74 | B8 | 62 × 88 | C8 | 57 × 81 |
| A9 | 37 × 52 | B9 | 44 × 62 | C9 | 40 × 57 |
| A10 | 26 × 37 | B10 | 31 × 44 | C10 | 28 × 40 |

As would be appreciated by those skilled in the art, the A and B series formats described so far relate to trimmed paper end sizes, i.e. these are the dimensions of paper that are delivered to the user or reader.

Industry standard sizes also include standardised dimensions for untrimmed raw paper. As such, ISO standards also define the format series RA and SRA for untrimmed raw paper, where SRA stands for “supplementary raw format A” (“sekundäres Rohformat A”). These formats are only slightly larger than the corresponding A series formats and are typically cut to the end format after binding.

As an example, the ISO RAO format has an area of 1.05 m² and the ISO SRAO format has an area of 1.15 m². These formats also follow the \sqrt{5} ratio and half-area rule, but the dimensions of the start format have been rounded to the full centimeter. These industry standard sized paper formats are defined in the following table.

| | |
|---|---|
| RA Series Formats | SRA Series Formats |

| | | | |
|---|---|---|---|
| RA0 | 860 × 1220 | SRA0 | 900 × 1280 |
| RA1 | 610 × 860 | SRA1 | 640 × 900 |
| RA2 | 430 × 610 | SRA2 | 450 × 640 |
| RA3 | 305 × 430 | SRA3 | 320 × 450 |
| RA4 | 215 × 305 | SRA4 | 225 × 320 |

In this illustrative embodiment, the insert sheets are formed from A4 size paper (i.e. 210×297 mm) and the envelope sheet is formed from OA4 (otherwise known as RA4) size paper (i.e. 215×305 mm).

Individual sheets 231, 232 (of size OA4) and envelope sheet 230 (of size OA4) are then collated 240 to form a document set 250.

Printer 210 in this embodiment is a high speed digital laser printer which will print and supply the document sets 250 in collated order as a single operation. Similarly, printer 210 could be an ink-jet printer or other printing means as is known in the art.

Envelope sheet 230 may be either pre-processed prior to collation or post-processed after collation as desired. In one illustrative embodiment, envelope sheet 230 as supplied by printer 210 is diverted to be die cut to form a standard envelope prior to collation, and then provided sequentially in-line as an envelope to form the document set. Insert sheets 231, 232 are then inserted into the formed envelope to form a bulk mail out item following an integrity check, which ensures that the formed envelope corresponding to envelope sheet 230 has been correctly matched to insert sheets 231, 232.

In an alternative embodiment, envelope sheet 230 is folded about insert sheets 231, 232 after collation by a wrapping machine to form a bulk mail out item after an integrity check has been performed on the combination of envelope sheet 230 and insert sheets 231, 232, this process once again ensuring correct matching of the folded or wrapped envelope with the corresponding insert sheets.

In another illustrative embodiment, the envelope sheet 230 and insert sheets 231, 232 may be printed using separate printers and then collated by providing each of the printed sheets sequentially in-line in collated order to form the document set. Once again, envelope sheet 230 may be pre-processed by die cutting or similar envelope forming operation prior to collation or alternatively post-processed by folding or wrapping envelope sheet 230 about insert sheets 231, 232 after integrity checking and forming of the bulk mail out item depending on requirements.

In another illustrative embodiment, the envelope sheet 230 and the insert sheets 231, 232 may be printed on a single industry standard rectangular sized sheet each with their associated unique IDCODE. Following this printing step, the sheet will comprise an envelope portion and insert sheet portions corresponding to the envelope sheet 230 and the associated insert sheets 231, 232. Following the printing step, the sheet is then cut into the individual envelope sheet 230 and the associated insert sheets 231, 232. In this illustrative embodiment, envelope sheet 230 and insert sheets 231, 232 may be cut in accordance with industry standard sizes or alternatively be cut to non-standard sizes as required. The envelope sheet 230 may then be pre-processed by die cutting or similar envelope forming operation prior to collation or alternatively post-processed by folding or wrapping envelope sheet about insert sheets 231, 232 as has been described previously.

After formation of the document set 250 no further printing is required, unlike prior art systems where insert sheets and envelopes are printed at different stages of the process.

A brief consideration of the above described embodiment will indicate that the invention provides an extremely simple and robust system for forming a document set which is effective to accommodate different industry standard paper sizes.

Although a preferred embodiment of the method and system of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A method for forming a document set, the document set formed from rectangular sheets and including an envelope sheet and at least one insert sheet, the at least one insert sheet and the envelope sheet selected from a range of industry standard rectangular sizes, the method including the steps of:
printing the envelope sheet with envelope information, the envelope information including a unique code identifier;
printing each of the at least one insert sheets with insert information, the insert information including a unique code identifier; and
collating the envelope sheet and the at least one insert sheet to form the document set.

2. The method for forming a document set as claimed in claim 1, wherein there are a plurality of insert sheets and wherein the plurality of insert sheets are of the same industry standard rectangular size.

3. The method for forming a document set as claimed in claim 1, further including the step of forming the envelope sheet into an envelope and wherein the step of collating includes collating the envelope and the at least one insert sheet to form the document set.

4. The method for forming a document set as claimed in claim 3, wherein the step of forming the envelope sheet into an envelope includes die cutting the envelope sheet.

5. The method for forming a document set as claimed in claim 2, further including the step of fainting the envelope into an envelope by folding or wrapping the envelope sheet about the least one insert sheet.

6. The method for forming a document set as claimed in claim 1, further including the step of verifying the document set by reading each of the unique code identifiers and performing a self-referencing integrity check.

7. The method for forming a document set as claimed in claim 1, wherein the unique code identifier identifies whether a printed sheet is an envelope sheet.

8. A method for forming a document set, the document set formed from a rectangular sheet of an industry standard rectangular size, the document set including an envelope sheet and at least one insert sheet, the method including the steps of:
printing an envelope sheet portion of the rectangular sheet with envelope information, the envelope information including a unique code identifier and the envelope sheet portion corresponding to the envelope sheet;
printing an at least one insert sheet portion of the rectangular sheet with insert information, the insert information including a unique code identifier, the at least one insert sheet portion corresponding to the at least one insert sheet;
cutting the rectangular sheet to form the envelope sheet and the at least one insert sheet; and
collating the envelope sheet and the at least one insert sheet to form the document set.

9. The method for forming a document set as claimed in claim 8, wherein the envelope sheet portion is of an industry standard rectangular size.

10. The method for forming a document set as claimed in claim 8, wherein the at least one insert sheet portion is of an industry standard rectangular size.

11. The method for forming a document set as claimed in claim 8, further including the step of verifying the document set by reading each of the unique code identifiers and performing a self-referencing integrity check.

12. The method for forming a document set as claimed in claim 8, wherein the unique code identifier identifies whether a printed sheet portion is an envelope sheet portion.

13. A bulk mail out item formed from the document set of claim 8.

14. An apparatus for forming a document set, the document set formed from rectangular sheets and including an envelope sheet and at least one insert sheet, the at least one insert sheet and the envelope sheet selected from a range of industry standard rectangular sizes, the apparatus including:
printing means for printing the envelope sheet with envelope information, the envelope information including a unique code identifier and to print each of the at least one insert sheets with insert information, the insert information including a unique code identifier; and
collating means for collating the envelope sheet and the at least one insert sheet to form the document set.

15. The apparatus for forming a document set as claimed in claim 14, wherein there are a plurality of insert sheets and wherein the plurality of insert sheets are of the same industry standard rectangular size.

16. The apparatus for forming a document set as claimed in claim 14, including envelope forming means for forming an envelope prior to collation.

17. The apparatus for forming a document set as claimed in claim 16, wherein the envelope forming means is a die cutter.

18. An apparatus for forming a document set, the document set formed from a rectangular sheet of an industry standard rectangular size, the document set including an envelope sheet and at least one insert sheet, the apparatus including:
printing means for printing an envelope sheet portion of the rectangular sheet with envelope information, the envelope information including a unique code identifier and the envelope sheet portion corresponding to the envelope sheet, and to print at least one insert sheet portion of the rectangular sheet with insert information, the insert information including a unique code identifier, the at least one insert sheet portion corresponding to the at least one insert sheet;
cutting means for cutting the rectangular sheet to fowl the envelope sheet and the at least one insert sheet; and
collating means for collating the envelope sheet and the at least one insert sheet to form the document set.

19. The apparatus of claim 18, wherein the envelope sheet portion is of an industry standard rectangular size.

20. The apparatus of claim 18, wherein the at least one insert sheet portion is of an industry standard rectangular size.
